(19) United States
(12) Patent Application Publication
(10) Pub. No.: US 2013/0097500 A1
(43) Pub. Date: Apr. 18, 2013

(54) METHOD AND SYSTEM FOR PROVIDING POSITIONABLE DYNAMIC CONTENT

(71) Applicant: Salesforce.com, inc., San Francisco, CA (US)

(72) Inventor: Vinodh Rajagopal, Sunnyvale, CA (US)

(73) Assignee: Salesforce.com, inc., San Francisco, CA (US)

(21) Appl. No.: 13/632,966

(22) Filed: Oct. 1, 2012

Related U.S. Application Data
(60) Provisional application No. 61/543,376, filed on Oct. 5, 2011.

(51) Int. Cl. G06F 3/0481

(52) U.S. Cl. CPC G06F 3/0481
USPC 715/711

(57) ABSTRACT

Systems and methods are provided for providing positionable dynamic content. A system receives a selection of a part of help options displayed by a user interface. The system identifies content corresponding to the part of help options and a location of a displayed element corresponding to the part of help options. The system loads a tooltip with the content corresponding to the part of help options. The system outputs the tooltip at a position based on the location of the displayed element corresponding to the part of help options via the user interface.

### CLAIM OF PRIORITY

This application claims the benefit of U.S. Provisional Patent Application 61/543,376 entitled METHODS AND SYSTEMS FOR PROVIDING DYNAMICALLY POSITIONABLE CONTENT, by Vinodh Rajagopal, filed Oct. 5, 2011 (Attorney Docket No. 775 PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### PROVIDING POSITIONABLE DYNAMIC CONTENT

One or more implementations relate generally to providing positionable dynamic content.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Online help is topic-oriented, procedural, or reference information delivered through computer software as a form of user assistance. Most online help is designed to give assistance in the use of a software application or an operating system. Online help that is linked to what the user is doing, a specific point in the state of a software application, is called context-sensitive help. Context-sensitive help, as opposed to general online help or online manuals, does not need to be accessible for reading as a whole, in which each help topic describes extensively one state, situation, or feature of a software application. Context-sensitive help can be implemented by displaying a tooltip in response to a user's pointer clicking on or hovering over a help button icon. The tooltip may be referred to as a “help bubble,” which includes text or other content, and usually “points” to an area on a web page and provides details about that section of the web page. Current methods for providing help bubbles consists of significant amounts of hard-coding of the position of the help bubble with respect to the element referenced by the help bubble, and also includes many browser specific tweaks. Current methods for providing help bubbles also involves code duplication because many software development frameworks are based on template engines that require a new template file, corresponding renderer, and class for each help bubble. Current help bubbles may be implemented with a heavy weight because all help bubbles that can possibly appear on a web page are loaded into the web page for display, even if on many occasions most of the help bubbles may never be called. Accordingly, it is desirable to provide techniques that enable a database system to improve the performance, efficiency, and the ease of use of help bubbles, or tooltips.

### BRIEF SUMMARY

In accordance with embodiments, there are provided systems and methods for providing positionable dynamic content. The system receives a selection of a help option displayed by a user interface. For example, a user selects the “invite people” help option out of eleven displayed help options to learn about a new business information networking application. The system identifies content corresponding to the selected help option and a location of a displayed element corresponding to the selected help option. For example, the system identifies “Invite your colleagues to join. They don't have to be chatter users.” text and the location of the “Members” icon, both of which correspond to the “invite people” help option. The system loads a tooltip with the content corresponding to the selected help option. For example, the system dynamically loads the only tooltip required with the “Invite your colleagues to join. They don't have to be chatter users.” text. The system outputs the tooltip at a position based on the location of the displayed element corresponding to the selected help option via the user interface. For example, the system displays the “Invite your colleagues to join. They don't have to be chatter users.” tooltip to the left of the “Members” icon. Accordingly, systems and methods are provided which enable a database system to improve the performance, efficiency, and the ease of use of help bubbles, which are positionable dynamic content in embodiments of the present disclosure.

While one or more implementations and techniques are described with reference to an embodiment in which providing positionable dynamic content is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of a method for providing positionable dynamic content in an embodiment;

FIG. 2 is a screen shot illustrating a frame of an example user interface screen of a display device supporting methods for providing positionable dynamic content;

FIG. 3 illustrates a block diagram of an example of an environment wherein an on-demand database service might be used; and

FIG. 4 illustrates a block diagram of an embodiment of elements of FIG. 3 and various possible interconnections between these elements.

### DETAILED DESCRIPTION

### General Overview

Systems and methods are provided for providing positionable dynamic content.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing positionable dynamic content will be described with reference to example embodiments.

The following detailed description will first describe a method for dynamically loading a tooltip with content corresponding to a selected help option and outputting the tooltip at a position based on the location of a displayed element corresponding to the selected help option.

Next, a screen shot illustrating a frame of an example user interface screen is described.

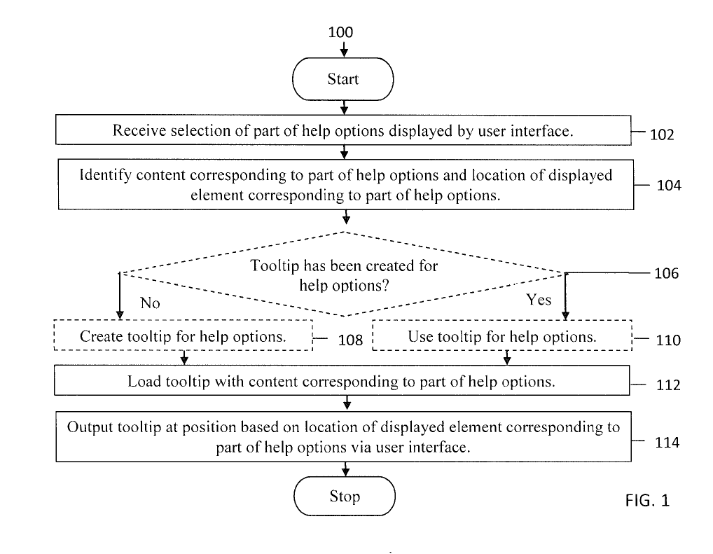

FIG. 1 is an operational flow diagram illustrating a high level overview of a method 100 for providing positionable dynamic content in an embodiment. As shown in FIG. 1, a database system can dynamically load a tooltip with content corresponding to a selected help option and output the tooltip at a position based on the location of a displayed element corresponding to the selected help option.

In block 102, a selection is received of a help option displayed by a user interface. For example and without limitation, this can include the database system receiving selection by a user of the “invite people” help option out of eleven displayed help options to learn about a new business information networking application. The selection of the part of help options is based on a pointer hovering over a part of help options and/or the pointer selecting a part of help options.

In block 104, content corresponding to a selected help option and a location of a displayed element corresponding to the selected help option are identified. By way of example and without limitation, this can include the database system identifying “Invite your colleagues to join. They don't have to be chatter users.” text and the location of the “Members” icon, both of which correspond to the “invite people” help option.

In prior art systems, all tooltips that can possibly appear on a webpage are loaded into a webpage for display even if most of the tooltips may never get called, and the caller typically has to compute and/or adjust the location of a tooltip with respect to the parent element to which the tooltip needs to point. In contrast, the database system uses only one tooltip and executes a single line of code to dynamically identify the content and the location of the tooltip. The code may be written in Javascript using cascading style sheets. (Java™ is a trademark of Sun Microsystems, Inc.) Browser specific tweaks are unnecessary because Javascript is cross-browser compliant. The code required for the webpage is lightweight because only a single line of code needs to be executed and every possible tooltip does not need to be created. Therefore the lightweight code may be easily executed solely on the client side instead of on the server side. In contrast to prior art template engines that require a new template file, corresponding renderer, and class for each tooltip, the database system uses only a single tooltip and a single line of code for each of the help options.

In block 106, a determination is made whether a tooltip has been created for help options. In embodiments, this can include the database system determining whether the only tooltip that may be needed has already been created for the help options. If the database system determines that a tooltip has not been created for the help options, the method 100 continues to block 108. If the database system determines that a tooltip has been created for the help options, the method 100 proceeds to block 110.

In block 108, a tooltip is created for help options. For example and without limitation, the database system creates one and only one tooltip for the help options because no tooltip exists. Then the method 100 proceeds to block 112.

In block 110, the tooltip is used for help options. For example and without limitation, the database system uses the already existing tooltip for the help options for dynamically loading with new content. Then the method 100 continues to block 112.

In block 112, a tooltip is loaded with content corresponding to a selected help option. In embodiments, the database system dynamically loads the only tooltip required with the “Invite your colleagues to join. They don't have to be chatter users.” text.

In block 114, a tooltip is output at a position based on a location of a displayed element corresponding to a selected help option via a user interface. For example and without limitation, the database system displays the “Invite your colleagues to join. They don't have to be chatter users.” tooltip to the left of the “Members” icon.

The tooltip includes a pointer that points to the location of the displayed element corresponding to the selected help option, with the position of the tooltip and the pointer relative to the tooltip based on a parameter. For example, the relative position of the tooltip may be to the left, to the right, above, or below the location of the displayed element, or a combination of these relationships to location of the displayed element. In contrast to prior art systems that hard-code the position of the tooltips relative to the displayed elements, the database system dynamically calculates the position of the tooltip based on two primary inputs, the displayed element which is pointed to and the direction of the pointer. The database system offers customizations with respect to positioning and alignment, as the default position of the tooltip and the pointer relative to the displayed element may be offset through selected parameters. For example, parameters may specify whether a tooltip is further or closer than a standard distance to the displayed element, and the parameters may specify whether the pointer is connected to the tooltip on the middle of a tooltip side or closer to the edge of a tooltip side.

The method 100 may be repeated as desired. Although this disclosure describes the blocks 102-114 executing in a particular order, the blocks 102-114 may be executed in a different order.

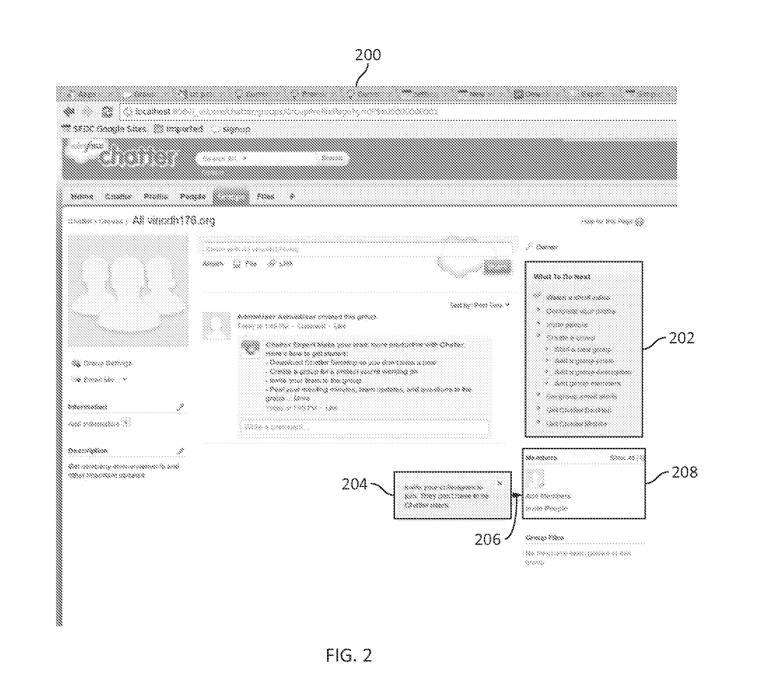

FIG. 2 is a screen shot illustrating a frame 200 of an example user interface screen of a display device for providing positionable dynamic content in an embodiment. The frame 200 may include help options 202, a tooltip 204, a tooltip pointer 206, and a “Members” icon 208. When a user selects the “invite people” help option out of eleven displayed help options 202 to learn about a new business information networking application, the database system dynamically loads the “Invite your colleagues to join. They don't have to be chatter users.” content in the tooltip 204 and displays the tooltip 204 at a position to the left of the “Members” icon 208. The tooltip 204 may be displayed to the left of the “Members” icon because the frame 200 does not include sufficient space to display the tooltip 204 to the right of the “Members” icon 208 or below the “members” icon 208 and because the help options 202 are displayed above the “Members” icon 208. The pointer 206 is depicted as connected to the middle of the right side of the tooltip 204, but parameters may relocate the pointer 206 more towards the top or the bottom of the right side of the tooltip 204.

The frame 200 may be part of a larger display screen that includes fields for users to enter commands to create, retrieve, edit, and store records. The database system may output a display screen that includes the frame 200 in response to a search based on search criteria input via a user interface.

Because the frame 200 is a sample, the frame 200 could vary greatly in appearance. For example, the relative sizes and positioning of the text is not important to the practice of the present disclosure. The frame 200 can be depicted by any visual display, but is preferably depicted by a computer screen. The frame 200 could also be output as a report and printed or saved in electronic format, such as PDF. The frame 200 can be part of a personal computer system and/or a network, and operated from system data received by the network, and/or on the Internet. The frame 200 may be navigable by a user. Typically, a user can employ a touch screen input or a mouse input device to point-and-click to a location on the frame 200 to manage the text on the frame 200, such as a selection that enables a user to edit the text. Alternately, a user can employ directional indicators, or other input devices such as a keyboard. The text depicted by the frame 200 is an example, as the frame 200 may include a much greater amount of text. The frame 200 may also include fields in which a user can input textual information.

### System Overview

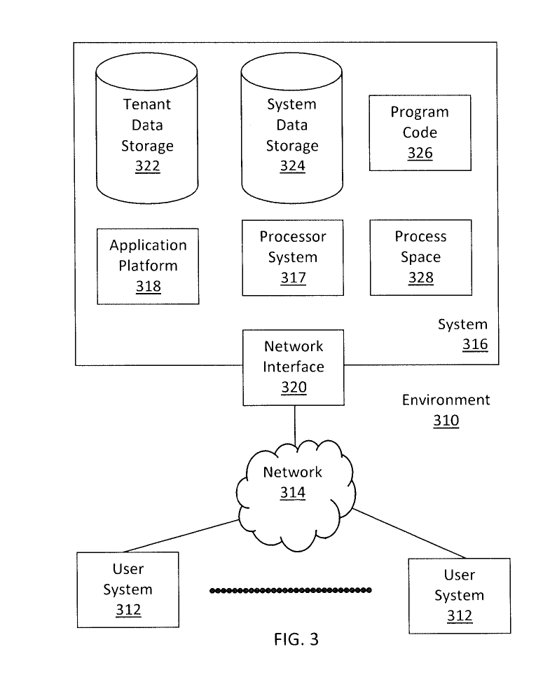

FIG. 3 illustrates a block diagram of an environment 310 wherein an on-demand database service might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

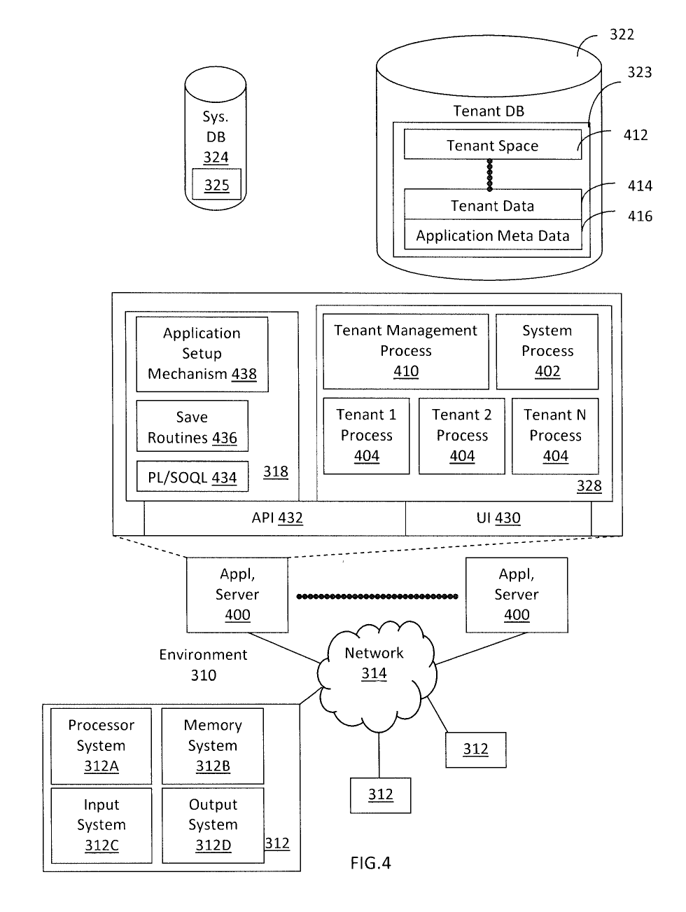

Environment 310 is an environment in which an on-demand database service exists. User system 312 may be any machine or system that is used by a user to access a database user system. For example, any of user systems 312 can be a handheld computing device, a mobile phone, a laptop computer, a work station, and/or a network of computing devices. As illustrated in FIG. 3 (and in more detail in FIG. 4) user systems 312 might interact via a network 314 with an on-demand database service, which is system 316.

An on-demand database service, such as system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database service 316 may include an application platform 318 that enables creation, managing and executing one or more applications developed by the provider of the on-demand database service, users accessing the on-demand database service via user systems 312, or third party application developers accessing the on-demand database service via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where more than one is present) and all of their components might be operator configurable using application(s) including computer code to run using a central processing unit such as processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 34 that provides a programming language style interface extension to API 432. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. An apparatus for providing positionable dynamic content, the apparatus comprising:
a processor; and
one or more stored sequences of instructions which, when executed by the processor, cause the processor to carry out the steps of:
receiving a selection of a part of help options displayed by a user interface;
identifying content corresponding to the part of help options and a location of a displayed element corresponding to the part of help options;
loading a tooltip with the content corresponding to the part of help options; and
outputting the tooltip at a position based on the location of the displayed element corresponding to the part of help options via the user interface.

2. The apparatus of claim 1, wherein the selection of the part of help options is based on at least one of a pointer hovering over the part of help options and the pointer selecting the part of help options.

3. The apparatus of claim 1, wherein the tooltip is the only tooltip output via the user interface.

4. The apparatus of claim 1, wherein the tooltip comprises a pointer that points to the location of the displayed element corresponding to the part of help options, and wherein a position of the pointer relative to the tooltip is based on a parameter.

5. A machine-readable medium carrying one or more sequences of instructions for providing positionable dynamic content, which instructions, when executed by one or more processors, cause the one or more processors to carry out the steps of:
receiving a selection of a part of help options displayed by a user interface;
identifying content corresponding to the part of help options and a location of a displayed element corresponding to the part of help options;
determining whether a tooltip has been created for the help options;
creating the tooltip for the help options in response to a determination that the tooltip has not been created for the help options;
loading the tooltip with the content corresponding to the part of help options; and
outputting the tooltip at a position based on the location of the displayed element corresponding to the part of help options via the user interface.

6. The machine-readable medium of claim 5, wherein the selection of the part of help options is based on at least one of a pointer hovering over the part of help options and the pointer selecting the part of help options.

7. The machine-readable medium of claim 5, wherein the tooltip is the only tooltip output via the user interface.

8. The machine-readable medium of claim 5, wherein the tooltip comprises a pointer that points to the location of the displayed element corresponding to the part of help options, and wherein a position of the pointer relative to the tooltip is based on a parameter.

9. The machine-readable medium of claim 5, further comprising the step of using the tooltip for the help options in response to a determination that the tooltip has been created for the help options.

10. A method for providing positionable dynamic content, the method comprising:
receiving a selection of a part of help options displayed by a user interface;
identifying content corresponding to the part of help options, a location of a displayed element corresponding to the part of help options, and a relative position to the location of the displayed element;
loading a tooltip with the content corresponding to the part of help options; and
outputting the tooltip at a position based on the location of the displayed element corresponding to the part of help options and the relative position to the location of the displayed element via the user interface.

11. The method of claim 10, wherein the selection of the part of help options is based on at least one of a pointer hovering over the part of help options and the pointer selecting the part of help options.

12. The method of claim 10, wherein the tooltip is the only tooltip output via the user interface.

13. The method of claim 10, wherein the tooltip comprises a pointer that points to the location of the displayed element corresponding to the part of help options, and wherein a position of the pointer relative to the tooltip is based on a parameter.

14. The method of claim 10, wherein the relative position to the location of the displayed element comprises left of the location of the displayed element, right of the location of the displayed element, above the location of the displayed element, below the location of the displayed element, and a combination of left of the location of the displayed element, right of the location of the displayed element, above the location of the displayed element, and below the location of the displayed element.

15. A method for transmitting code for providing positionable dynamic content, the method comprising:
transmitting code to receive a selection of a part of help options displayed by a user interface;
transmitting code to identify content corresponding to the part of help options, a location of a displayed element corresponding to the part of help options, and a relative position to the location of the displayed element;
transmitting code to determine whether a tooltip has been created for the help options;
transmitting code to create the tooltip for the help options in response to a determination that the tooltip has not been created for the help options
transmitting code to load the tooltip with the content corresponding to the part of help options; and
transmitting code to output the tooltip at a position based on the location of the displayed element corresponding to the part of help options and the relative position to the location of the displayed element via the user interface.

16. The method for transmitting code of claim 15, wherein the selection of the part of help options is based on at least one of a pointer hovering over the part of help options and the pointer selecting the part of help options.

17. The method for transmitting code of claim 15, wherein the tooltip is the only tooltip output via the user interface.

18. The method for transmitting code of claim 15, wherein the tooltip comprises a pointer that points to the location of the displayed element corresponding to the part of help options, and wherein a position of the pointer relative to the tooltip is based on a parameter.

19. The method for transmitting code of claim 15, further comprising transmitting code to use the tooltip for the help options in response to a determination that the tooltip has been created for the help options.

20. The method for transmitting code of claim 15, wherein the relative position to the location of the displayed element comprises left of the location of the displayed element, right of the location of the displayed element, above the location of the displayed element, below the location of the displayed element, and a combination of left of the location of the displayed element, right of the location of the displayed element, above the location of the displayed element, and below the location of the displayed element.
